(19) United States
(12) Patent Application Publication
(10) Pub. No.: US 2024/0428289 A1
(43) Pub. Date: Dec. 26, 2024

(54) REGION VALUE EVALUATION SYSTEM

(71) Applicant: NTT DOCOMO, INC., Tokyo (JP)

(72) Inventors: Ryousuke KURACHI, Chiyoda-ku (JP); Kengo MATSUMOTO, Chiyoda-ku (JP); Mikio IWAMURA, Chiyoda-ku (JP); Masayuki YOKOO, Chiyoda-ku (JP); Fuminori SHINSEI, Chiyoda-ku (JP); Shinji KIMURA, Chiyoda-ku (JP)

(73) Assignee: NTT DOCOMO, INC., Tokyo (JP)

(21) Appl. No.: 18/699,683

(22) PCT Filed: Sep. 30, 2022
(86) PCT No.: PCT/JP2022/036804

§ 371 Date: Apr. 9, 2024

(30) Foreign Application Priority Data
Oct. 11, 2021 (JP) 2021-166800

(51) Int. Cl. G06Q 30/0242

(52) U.S. Cl. CPC G06Q 30/0243

(57) ABSTRACT

A region value evaluation system is a system evaluating the value of a region to which display information to be displayed is allocated, in a virtual space that is used for a display in an information processing device and corresponds to a reality space in a position, and includes an evaluation information acquisition unit acquiring evaluation information including position information indicating the position in the reality space of the information processing device performing a display using the virtual space, and an evaluation unit performing aggregation based on the evaluation information acquired by the evaluation information acquisition unit to evaluate the value of the region on the basis of an aggregation result.

### TECHNICAL FIELD

The present invention relates to a region value evaluation system evaluating the value of a region in a virtual space.

### BACKGROUND ART

In the related art, it has been proposed to present an advertisement to a user in an augmented reality (AR) space that is a virtual space associated with a reality space (for example, refer to Patent Literature 1).

### CITATION LIST

### Patent Literature

Patent Literature 1: Japanese Unexamined Patent Publication No. 2021-103303

### SUMMARY OF INVENTION

### Technical Problem

It is considered that a business operator presenting an AR space sells a region for presenting a content such as an advertisement in an AR space to a third party. In order to sell the region in the AR space, it is necessary to set a price according to the region. However, in the related art, there is no method for suitably evaluating the value of the region, and such a method is required when selling the region.

One embodiment of the present invention has been made in consideration of the above, and an object thereof is to provide a region value evaluation system capable of suitably evaluating the value of a region for presenting display information such as an advertisement in a virtual space such as an AR space.

### Solution to Problem

In order to achieve the object described above, a region value evaluation system according to one embodiment of the present invention is a region value evaluation system evaluating the value of a region to which display information to be displayed is allocated, in a virtual space that is used for a display in an information processing device and corresponds to a reality space in a position, and includes an evaluation information acquisition unit acquiring evaluation information including position information indicating a position in the reality space of the information processing device performing a display using the virtual space, and an evaluation unit performing aggregation based on the evaluation information acquired by the evaluation information acquisition unit to evaluate the value of the region on the basis of an aggregation result.

In the region value evaluation system according to one embodiment of the present invention, the value of the region is evaluated by considering the position in the reality space of the information processing device performing the display using the virtual space. Accordingly, for example, the value of the region to be evaluated can be in accordance with an advertisement effect of the region. Therefore, according to the region value evaluation system according to one embodiment of the present invention, it is possible to suitably evaluate the value of the region for presenting the display information such as an advertisement in the virtual space such as an AR space.

### Advantageous Effects of Invention

According to one embodiment of the present invention, it is possible to suitably evaluate the value of the region for presenting the display information such as an advertisement in the virtual space such as an AR space.

### BRIEF DESCRIPTION OF DRAWINGS

FIG. 1 is a diagram illustrating a configuration of a region value evaluation system according to an embodiment of the present invention.

FIG. 2 is a diagram illustrating an example of an AR display in an information processing device.

FIG. 3 is a diagram illustrating value evaluation of a region in the region value evaluation system.

FIG. 4 is a diagram illustrating information used for the value evaluation of the region.

FIG. 5 is a diagram illustrating the information used for the value evaluation of the region.

FIG. 6 is a flowchart illustrating processing executed by the region value evaluation system according to the embodiment of the present invention.

FIG. 7 is a diagram illustrating a hardware configuration of the region value evaluation system according to the embodiment of the present invention.

### DESCRIPTION OF EMBODIMENTS

Hereinafter, an embodiment of a region value evaluation system according to the present invention will be described in detail together with the drawings. Note that, in the description of the drawings, the same reference numerals will be applied to the same elements, and the repeated description will be omitted.

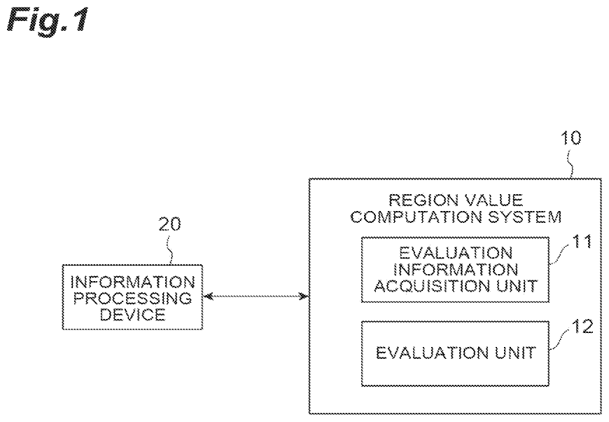

FIG. 1 illustrates a region value evaluation system 10 according to this embodiment. The region value evaluation system 10 is a system (a device) evaluating the value of a region to which display information to be displayed is allocated, in a virtual space that is used for a display in an information processing device 20 and corresponds to a reality space in a position. The virtual space, for example, is used for an AR display in the information processing device 20. In this embodiment, the virtual space used for the AR display will be described as an example. Note that, insofar as the virtual space is used for the display in the information processing device 20 and corresponds to the reality space in the position, the virtual space may be used for other than the AR display.

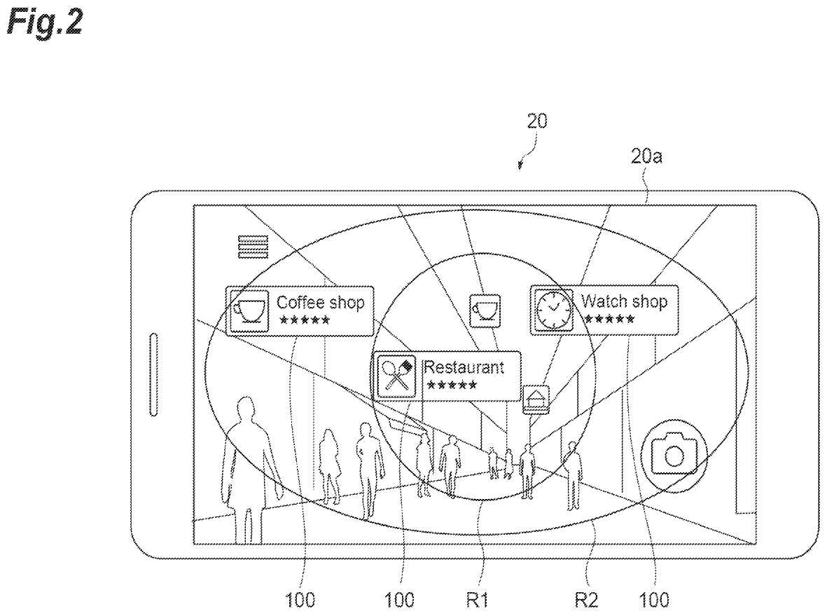

FIG. 2 illustrates an example of the AR display in the information processing device 20. In the AR space that is the virtual space used for the AR display, a content 100 that is the display information displayed on the information processing device 20 is allocated to a region positioned in advance. A position in the AR space corresponds to a position in the reality space. Accordingly, the region in the AR space to which the content 100 is allocated also corresponds to any position in the reality space. In the region value evaluation system 10, a correspondence relationship in the positions between the AR space and the reality space is stored in advance, and the stored correspondence relationship in the positions is used for the function of the region value evaluation system 10 described below.

The information processing device 20 is a device that is carried and used by a user, and for example, is a mobile communication terminal such as a smart phone. Alternatively, the information processing device 20 is a device mounted on the user, and for example, may be an AR glass (in this case, the information processing device 20 is mounted on the head of the user, specifically, the eye portion). Note that, in FIG. 2, only one information processing device 20 is drawn, but in general, there are a plurality of information processing devices 20 used by a plurality of users, respectively.

The information processing device 20 includes an imaging device and a display device. The imaging device may be an existing one, such as a camera generally provided in a smart phone or the like. The display device may be an existing one, such as a display generally provided in a smart phone or the like. As illustrated in FIG. 2, the information processing device 20 displays an image of the reality space imaged by the imaging device on a display screen 20a of the display device. The information processing device 20 displays the content 100 allocated to the region in the AR space corresponding to the position in the reality space captured in the image to be superimposed on the image of the reality space. The content 100, for example, is an advertisement. That is, the content 100 is used as a virtual signboard in the AR display. Note that, the content 100 is not necessarily the advertisement, and may be any content insofar as the content is allocated to the AR space and displayed on the information processing device 20.

The AR display in the information processing device 20 may be performed as with the related art. For example, the AR display may be performed by an application for an AR display installed in the information processing device 20. The information processing device 20 performs transmission and reception of information with a server for an AR display to perform the AR display by the application. Note that, the AR display may be performed by a method other than the above. In addition, the function of the information processing device 20 according to this embodiment described below may be implemented by the application for an AR display.

A business operator allowing the information processing device 20 to perform the AR display (for example, a business operator providing the server and the application for an AR display) is capable of providing the region to which the content 100 in the virtual space is allocated to a third party at a cost. That is, the third party is capable of purchasing the right to present an advertisement in the AR space and presenting the advertisement in the AR space. Since the position in the AR space corresponds to the position in the reality space, the region in the AR space includes a region that is highly likely to be viewed by the user (with high browsability) and a region with low browsability. It is considered to make the price of the region with high browsability high, and the price of the region with low browsability low. For example, it is considered to sell the content allocation right of a certain region set as 1000000 yen/h, the content allocation right of another region set as 300000 yen/h, and the content allocation right of the other region set as 500000 yen/h to a content provider.

The region value evaluation system 10 evaluates the value of the region to which the content 100 is allocated in the AR space. The value of the region evaluated by the region value evaluation system 10 may be the price itself as described above, or may be the basis for the price of the region. The value of the region in the AR space, for example, increases as the region is more likely to be browsed by the user and an advertisement effect increases. Note that, the region value evaluation system 10 may evaluate the value of the region with evaluation criteria other than the criteria described above. In addition, the region value evaluation system 10 may evaluate a value having meaning other than the price.

The region value evaluation system 10 may be composed of a computer such as a personal computer (PC) or a server device. The region value evaluation system 10 may be composed of a plurality of computers, that is, a computer system. Each of the region value evaluation system 10 and the information processing device 20 has a communication function, and is capable of performing transmission and reception of information with each other via a communication network. The communication function may be an existing one.

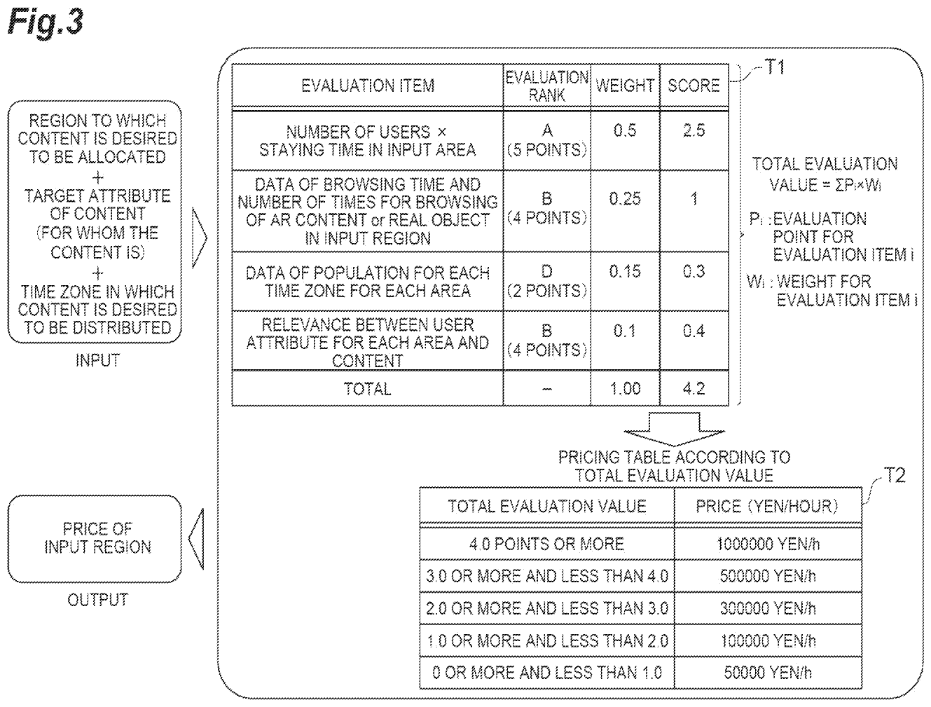

As illustrated in FIG. 3, for example, the region value evaluation system 10 receives the input of information relating to an evaluation request, and outputs information indicating the price in accordance with the information. For example, a person who desires to present the content 100 in the AR space inputs the information relating to the evaluation request to find out the price for presenting the content 100. The information relating to the evaluation request is information indicating a region in the AR space to which the content 100 is desired to be allocated, target attribute of the content 100 (for whom the content 100 is), and a time zone in which the content is desired to be distributed (presented). The region value evaluation system 10 outputs the price of the region in the AR space according to the input information.

Subsequently, the function of the region value evaluation system 10 according to this embodiment will be described. As illustrated in FIG. 1, the region value evaluation system 10 is configured by including an evaluation information acquisition unit 11 and an evaluation unit 12.

The evaluation information acquisition unit 11 is a function unit acquiring evaluation information used for the value evaluation of the region in the virtual space. The evaluation information acquisition unit 11 acquires the evaluation information including position information indicating the position in the reality space of the information processing device 20 performing a display using the virtual space. The evaluation information acquisition unit 11 may acquire the evaluation information including display status information indicating a display status using the virtual space in the information processing device 20. The evaluation information acquisition unit 11 may acquire the evaluation information including display status information indicating a time-series display status using the virtual space in the information processing device 20.

The evaluation information acquisition unit 11 may acquire the image of the reality space imaged by the imaging device provided in the information processing device 20, estimate the position of the information processing device 20 on the basis of the acquired image of the reality space, and acquire the position information. The evaluation information acquisition unit 11 may acquire the evaluation information including the image of the reality space imaged by the imaging device provided in the information processing device 20. The evaluation information acquisition unit 11 may acquire the evaluation information including the time-series images of a space imaged by the imaging device provided in the information processing device 20. The evaluation information acquisition unit 11 may acquire the evaluation information according to time. The evaluation information acquisition unit 11 may acquire the evaluation information including attribute information indicating the attribute of the user of the information processing device 20.

For example, the evaluation information acquisition unit 11 acquires the evaluation information as described below. The information processing device 20 transmits an image being displayed when the own device 20 performs the AR display to the region value evaluation system 10. The image being displayed when the information processing device 20 performs the AR display, that is, the image to be transmitted to the region value evaluation system 10 from the information processing device 20, as described above, is an image in which the content 100 in the AR space is superimposed on the image of the reality space imaged by the imaging device provided in the information processing device 20. The image to be transmitted to the region value evaluation system 10 from the information processing device 20 is the image of the reality space and is the display status information indicating the display status using the virtual space. For example, when the own device 20 operates the application for an AR display, the information processing device 20 performs the transmission described above by the application.

The evaluation information acquisition unit 11 receives and acquires the image transmitted from the information processing device 20. The evaluation information acquisition unit 11 estimates the position in the reality space of the information processing device 20 on the basis of the acquired image, and acquires the position information indicating the position in the reality space of the information processing device 20. The position information, for example, is information indicating the coordinates (for example, the latitude and the longitude) in the reality space. Here, the position information may be information other than the above insofar as the position information indicates the position in the reality space of the information processing device 20. The estimation of the position from the image may be performed by an existing technology. For example, the evaluation information acquisition unit 11 stores in advance the information indicating the position and information according to an image such as a feature point in association with each other. The evaluation information acquisition unit 11 extracts information according to the input image such as the feature point of the acquired image. The evaluation information acquisition unit 11 matches the extracted feature point or the like to the stored information according to the image such as a feature point. The evaluation information acquisition unit 11 estimates the position of the information processing device 20 from the stored associated information and a result of matching.

The information processing device 20 periodically transmits the images to the region value evaluation system 10 while the application for an AR display is operated in the own device 20. That is, the information processing device 20 transmits time-series images to the region value evaluation system 10. For example, the information processing device 20 may transmit a moving image to the region value evaluation system 10. The evaluation information acquisition unit 11 estimates the position described above each time when the image is acquired from the information processing device 20.

The evaluation information acquisition unit 11 may acquire the position information of the information processing device 20 by a method other than the above. For example, the information processing device 20 may perform the positioning of the own device 20, and transmit the position information of the own device 20 to the region value evaluation system 10, and the evaluation information acquisition unit 11 may receive and acquire the position information transmitted from the information processing device 20.

The evaluation information acquisition unit 11 may set the image itself transmitted from the information processing device 20 as the evaluation information. As described above, the image is the image of the reality space and is the display status information indicating the display status using the virtual space. The image of the reality space and the display status information may be separate information, for example, separate images. The display status information may be an image in which the content 100 is displayed, that is, an image superimposed on the image of the reality space. In addition, the display status information is not necessarily an image, and may be information indicating the content 100 displayed in the image. In addition, the display status information may further be information indicating the position of the content 100 in the image (for example, the coordinates in the image).

The evaluation information acquisition unit 11 may acquire the evaluation information according to the time. For example, the information processing device 20 transmits the information such as an image to the region value evaluation system 10 in real time. The evaluation information acquisition unit 11 sets a time when the evaluation information such as an image is received from the information processing device 20 as a time according to the evaluation information such as an image. Alternatively, the information processing device 20 adds the information indicating the time to the evaluation information such as an image and transmits the evaluation information to which the information indicating the time is added to the region value evaluation system 10. For example, in the case of the image, the time is a time when the image is displayed on the information processing device 20, and in the case of the position information, the time is a time when positioning is performed in the information processing device 20. The evaluation information acquisition unit 11 receives and acquires the evaluation information such as an image to which the information indicating the time is added.

The evaluation information acquisition unit 11 may acquire the evaluation information including the attribute information indicating the attribute of the user of the information processing device 20. The attribute of the user, for example, is the gender and the age of the user. In addition, the attribute of the user may be other than the above (for example, the occupation). For example, the evaluation information acquisition unit 11 stores information in which an identifier of the information processing device 20 and the attribute information of the user of the information processing device 20 are associated with each other. The information processing device 20 adds the identifier of the own device 20 to the evaluation information such as an image, and transmits the evaluation information to which the identifier is added to the region value evaluation system 10. The evaluation information acquisition unit 11 receives and acquires the evaluation information such as an image to which the identifier of the information processing device 20 is added. The evaluation information acquisition unit 11 acquires the attribute information of the user that is stored in association with the acquired identifier.

The evaluation information acquisition unit 11 acquires a sufficient number of evaluation information pieces for the value evaluation of the region. For example, the evaluation information acquisition unit 11 acquires the evaluation information from the plurality of information processing devices 20 performing the AR display by the application for an AR display. The evaluation information acquisition unit 11 outputs the acquired evaluation information to the evaluation unit 12.

The evaluation unit 12 is a function unit performing aggregation based on the evaluation information acquired by the evaluation information acquisition unit 11 to evaluate the value of the region on the basis of an aggregation result. The evaluation unit 12 may evaluate the value of the region also in accordance with whether the region is included in the display using the virtual space in the information processing device 20, which is indicated by the display status information acquired by the evaluation information acquisition unit 11. The evaluation unit 12 may evaluate the value of the region also in accordance with the position of the region in the display using the virtual space in the information processing device 20. The evaluation unit may evaluate the value of the region also in accordance with the length of a time for which a state set in advance is continued, in a time-series display using the virtual space in the information processing device 20, which is indicated by the display status information acquired by the evaluation information acquisition unit 11.

The evaluation unit 12 may evaluate the value of the region also in accordance with whether a location corresponding to the region is included in the image of the reality space acquired by the evaluation information acquisition unit 11. The evaluation unit 12 may evaluate the value of the region also in accordance with the position of the location corresponding to the region in the image of the reality space. The evaluation unit 12 may evaluate the value of the region also in accordance with the length of a consecutive time for which the state set in advance is continued, in the time-series images of the reality space acquired by the evaluation information acquisition unit 11.

For example, the evaluation unit 12 evaluates the value of the region as follows. The evaluation unit 12 evaluates the value of a region set in advance in the virtual space. The region is the region to which the content 100 is allocated as described above. There may be a plurality of regions to be an evaluation target.

The evaluation unit 12 inputs the evaluation information from the evaluation information acquisition unit 11. The evaluation unit 12, as shown in a table T1 of FIG. 3, performs the aggregation based on the input evaluation information for each evaluation item set in advance. The number of evaluation items is 4 shown in the table T1 of FIG. 3. The evaluation unit 12 evaluates the value of the region from the aggregation result for each of the evaluation items. The value of the region, for example, is a price per hour, for example, a value in the unit of yen/hour. The evaluation unit 12 determines an evaluation rank on the basis of the aggregation result of the evaluation information for each of the evaluation items. There are five evaluation ranks of A (5 points) to E (1 point), and an evaluation point is associated with each of the evaluation ranks. The evaluation increases as the evaluation point increases.

The first evaluation item is the number of users×staying time in an area. The evaluation item is a value for each area set in advance in the reality space. The area, for example, is a mesh that divides the reality space into the shape of a rectangle. As this value increases, the value of the region of the content 100 that can be viewed by the user in the area increases.

The evaluation unit 12 computes the value described above from the position information that is one of the evaluation information. For example, the evaluation unit 12 determines which area each of the position information pieces is included in, and counts the number of position information pieces for each of the areas. The evaluation unit 12 computes the value of the number of users×staying time for each of the areas from the counted value. For example, the value of the number of users×staying time is computed by multiplying the counted value by a coefficient set in advance in the number of position information pieces (a coefficient according to a time interval of the position information).

The second evaluation item is a browsing time and the number of times for browsing of the content 100 or a real object in the region. The evaluation item is a value for each of the regions to be the evaluation target in the virtual space. As this value increases, the value of the region increases. Note that, the evaluation item is the browsing time and the number of times for browsing, but as described below, in practice, the browsing by the user of the information processing device 20 is not necessarily required.

The evaluation unit 12 determines whether the region is included in the AR display in the information processing device 20 on the basis of the evaluation information. For example, whether the content 100 allocated to the region to be the evaluation target is included (captured) in the image that is one of the evaluation information is determined. The determination may be performed by an existing technology. In addition, in a case where the evaluation information is information indicating the content 100 displayed in the image, the determination described above may be performed by using the information.

The evaluation unit 12 sets a time for which the content 100 is included in the image as the value of the browsing time according to the evaluation item described above. The computation of the time may be performed as with the computation of the time of the first evaluation item. Alternatively, the evaluation unit 12 sets the number of times for which the content 100 is included in the image as the value of the number of times for browsing according to the evaluation item described above. In this case, a time for which the content 100 is consecutively included in the image may be counted as one time.

In a case where the content 100 is not allocated to the region to be the evaluation target, the evaluation unit 12 determines whether the location corresponding to the region (that is, the real object) is included (captured) in the image of the reality space that is imaged by the imaging device provided in the information processing device 20 and is one of the evaluation information. In a case where the content 100 is allocated to the region in the AR space, the location included in the image of the reality space is a location where the content 100 is displayed. As described above, the position of the location in the reality space corresponding to the region in the AR space is a position according to the correspondence relationship between the AR space and the reality space, and grasped in advance in the region value evaluation system 10. The evaluation unit 12 determines whether the position described above is included in the image of the reality space. The determination may be performed by an existing technology. For example, a technology of grasping the position in the reality space in the image when performing the AR display may be used.

The evaluation unit 12 sets a time for which the location described above is included in the image of the reality space as the value of the browsing time according to the evaluation item described above. The computation of the time may be performed as with the computation of the time of the first evaluation item. Alternatively, the evaluation unit 12 sets the number of times for which the location described above is included in the image of the reality space as the number of times for browsing according to the evaluation item described above. In this case, a time for which the location described above is consecutively included in the image may be counted as one time.

In the above computation for this evaluation item, the time and the number of times for which the content 100 or the location corresponding to the region is included in the image are simply used. However, the evaluation unit 12 may compute the value of the evaluation item in accordance with the position of the region in the AR display in the information processing device 20, for example, the position of the content 100 in the image displayed on the information processing device 20. In addition, the evaluation unit 12 may compute the value of the evaluation item in accordance with the position of the location corresponding to the region to be the evaluation target in the image of the reality space.

For example, as illustrated in FIG. 2, only a case where the content 100 or the region to be the evaluation target is positioned in a circular region R1 (Near) set in advance, which is positioned at the center on the display screen of the information processing device 20, it may be used for the computation of the value of the evaluation item. Alternatively, an elliptical region R2 (Far) including the circular region R1 may be provided, in a case where the content 100 or the region to be the evaluation target is positioned in the region R1, the value of the evaluation item may be computed by applying a weight larger than that in a case where the content 100 or the region to be the evaluation target is positioned in the region R2.

This is because it is considered that the region to be the evaluation target displayed at a position closer to the center on the display screen of the information processing device 20 is highly likely to be browsed by the user of the information processing device 20 and has a high value.

The third evaluation item is a population (the number of users) for each time zone in the area. The evaluation item is a value for each combination of an area and a time zone set in advance in the reality space. As this value increases, the value of the region of the content 100 that can be viewed by the user in the area increases.

The evaluation unit 12 computes the value described above from the position information that is one of the evaluation information. For example, the evaluation unit 12 determines which area each of the position information pieces is included in, and counts the number of users based on the position information for each of the areas and time zones. The time zone, for example, is a time zone for each hour in 1 day. In addition, the time zone is not limited to the above, and may be the division of any time axis such as the day of the week. For the number of users based on the position information, in a case where there are one or more position information pieces for a certain user in the same area and the same time zone, 1 is counted for the user, and in a case where there is no position information for the certain user, 0 is counted for the user. Note that, the value of this evaluation item may be the value of the number of users×staying time as with the first evaluation item. In addition, the value of the first evaluation item may be the value of the number of users as with this evaluation item.

The fourth evaluation item is relevance between the user attribute and the content in the area. The evaluation item is a value for each of the areas set in advance in the reality space. In addition, the evaluation item is a value according to information indicating the target attribute of the content 100 that is one of the information relating to the evaluation request. The value indicates the degree of matching between the target attribute of the content 100 and the user attribute of the user in the area. As this value increases, the value of the region of the content 100 that can be viewed by the user in the area increases.

The evaluation unit 12 computes a population ratio (the users) for each of the user attribute pieces in each of the areas for computing the value described above from the position information and the attribute information that are the evaluation information. For example, the evaluation unit 12 determines which area each of the position information pieces is included in, and specifies the users positioned in the area. In a case where there are one or more position information pieces for a certain user in the same area, the user is set as the user positioned in the area, and in a case where there is no position information for the certain user, the user is not set as the user positioned in the area. The evaluation unit 12 computes the population ratio for each of the user attribute pieces with reference to the attribute information of the user positioned in the area for each of the areas. For example, for the users in a certain area, the evaluation unit 12 computes the population ratio for each of the user attribute pieces such that men in their teens are 40%, men in their 20s are 20%, and men in their 30s are 30%.

In the computation of the value for each of the evaluation items described above, the evaluation unit 12 may evaluate the value of the region also in accordance with the length of the time for which the state set in advance is continued, in the time-series display using the AR space in the information processing device 20. Alternatively, the evaluation unit 12 may evaluate the value of the region also in accordance with the length of the consecutive time for which the state set in advance is continued, in the time-series images of the reality space. Even in a case where the AR display is performed in the information processing device 20, the user is not necessarily actually browsing the AR display in the information processing device 20. As described above, by considering the length of the consecutive time for which the state set in advance is continued, it is possible to compute a value considering a case where the user is highly likely to browse the AR display in the information processing device 20.

For example, the evaluation unit 12 may compute the value for the evaluation item by using information only in a case where the AR display or the image of the reality space is not consecutively changed for a certain period of time (for example, for 3 seconds). The detection that the AR display or the image of the reality space is not consecutively changed for a certain period of time may performed by an existing technology using the display status information or the image of the reality space. This is because in a case where the AR display or the image of the reality space is not consecutively changed for a certain period of time, it is considered that the user is highly likely to be in the state of watching the display. On the other hand, in a case where the AR display or the image of the reality space is consecutively changed for a certain period of time, it is considered that the user is highly likely to be in the state of not watching the display, such as simply heading toward a destination. Alternatively, in a case where the length of the consecutive time described above is 3 seconds or longer, the value of the evaluation item may be computed by applying a weight larger than that in a case where the length of the consecutive time is shorter than 3 seconds.

In addition, for the same purpose, the evaluation unit 12 may compute the value of the evaluation item in accordance with the length of the consecutive time, in which the position of the region to be the evaluation target is included in the AR display in the information processing device 20. The evaluation unit 12 may compute the value of the evaluation item in accordance with the length of the consecutive time, in which the location corresponding to the region is included in the image of the reality space. For example, only a case where the length of the consecutive time described above is 3 seconds or longer is used for the computation of the value. The detection of whether the region to be the evaluation target is included in the AR display and the detection of whether the location corresponding to the region is included in the image of the reality space may be performed by an existing technology. Alternatively, in a case where the length of the consecutive time described above is 3 seconds or longer, the value of the evaluation item may be computed by applying a weight larger than that in a case where the length of the consecutive time is shorter than 3 seconds.

The evaluation unit 12 outputs information indicating the price that is an evaluation result in accordance with the input of the information relating to the evaluation request from the value of each of the evaluation items that is the aggregation result based on the evaluation information as described above. The information relating to the evaluation request is transmitted to the region value evaluation system 10 from the information processing device of the person who desires to present the content 100 in the AR space. The evaluation unit 12 receives the transmitted information relating to the evaluation request.

As described above, the information relating to the evaluation request is the information indicating the region in the AR space to which the content 100 is desired to be allocated, the target attribute of the content 100 (for whom the content 100 is), and the time zone in which the content is desired to be distributed (presented). The information indicating the region in the AR space to which the content 100 is desired to be allocated, for example, is information indicating the coordinates of the region (for example, the coordinates in a three-dimensional space). The information indicating the target attribute of the content 100, for example, is information indicating the gender and the age (the age group). In addition, the information may include a main target and a sub-target. A specific example of the information is information in which the main target is for men in their 30s, and the sub-target is for men in their 20s. The information indicating the time zone in which the content is desired to be distributed, for example, is information indicating a time zone in the unit of 1 hour in 1 day (for example, 8:00 to 9:00).

The evaluation unit 12 computes the price of the region from the information relating to the evaluation request and the value of each of the evaluation items. The evaluation unit 12 specifies an area in the reality space used for the evaluation from the information indicating the region in the AR space to which the content 100 is desired to be allocated. For example, an area including a position in the reality space corresponding to the region to which the content 100 is desired to be allocated is specified as the area in the reality space used for the evaluation on the basis of the stored correspondence relationship in the positions between the AR space and the reality space. Alternatively, the region in the AR space and the area in which the content 100 allocated to the region can be browsed may be associated with each other in advance and stored in the evaluation unit 12, and the area associated with the region in the AR space to which the content 100 is desired to be allocated may be specified as the area in the reality space used for the evaluation.

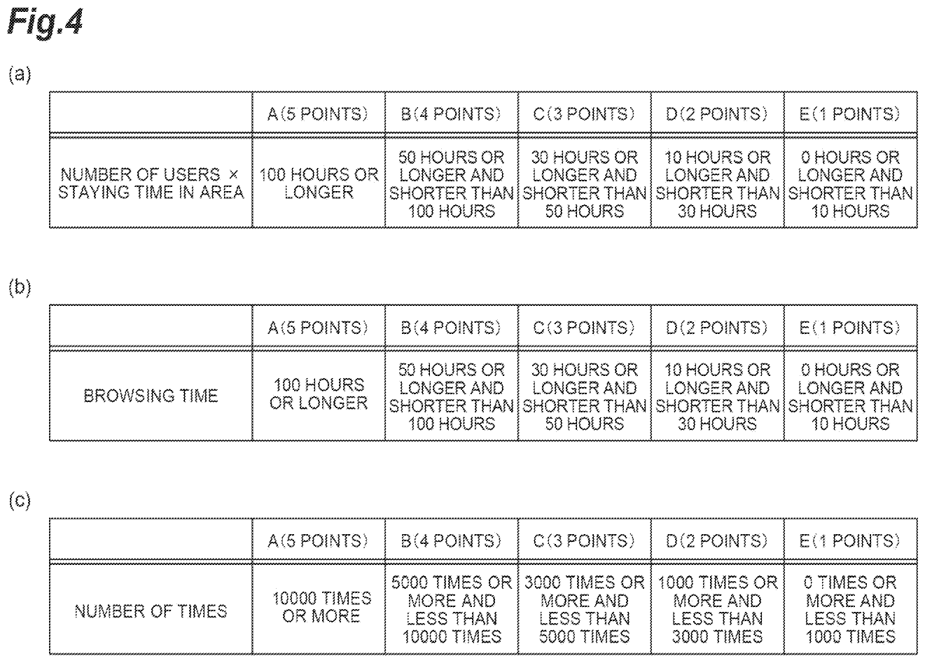

The evaluation unit 12 refers to the value of the number of users×staying time (the first evaluation item) computed for the specified area. The evaluation unit 12 stores in advance information indicating a correspondence relationship between the evaluation rank and the number of users×staying time illustrated in FIG. 4(a). The evaluation unit 12 determines the evaluation rank from the value of the number of users×staying time for the specified area on the basis of the stored correspondence relationship. Note that, in a case where there are a plurality of specified areas, the evaluation rank may be determined by computing a value for determining the evaluation rank (for example, an average value or an added value to which weighting set in advance is applied) from the value of the number of users×staying time of each of the areas (the same applies to the evaluation item using the value for each of the areas).

The evaluation unit 12 refers to the value of the browsing time and the number of times for browsing (the second evaluation item) of the content 100 or the real object computed for the region in the AR space to which the content 100 is desired to be allocated. The evaluation unit 12 stores in advance information indicating a correspondence relationship between the evaluation rank and the browsing time illustrated in FIG. 4(b). The evaluation unit 12 stores in advance information indicating a correspondence relationship between the evaluation rank and the number of times for browsing illustrated in FIG. 4(c). The evaluation unit 12 determines the evaluation rank from the computed value of the browsing time and the number of times for browsing on the basis of the stored correspondence relationship. Note that, for this evaluation item, the evaluation rank may be determined from either the browsing time or the number of times for browsing. Alternatively, the evaluation rank may be determined from both of the browsing time and the number of times for browsing. In this case, for example, the average of the evaluation rank determined from the browsing time and the evaluation rank determined from the number of times for browsing may be the evaluation rank of this evaluation item.

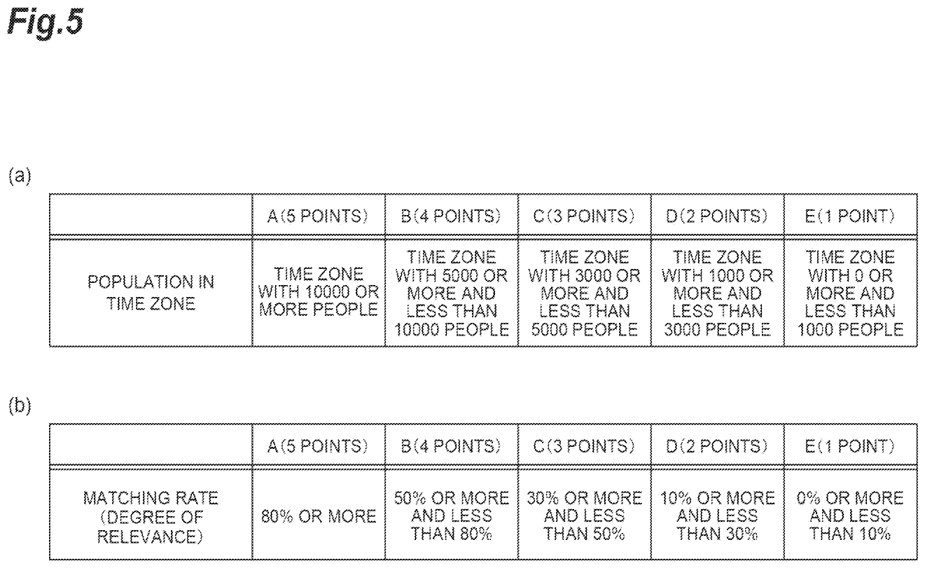

The evaluation unit 12 refers to the value of the population (the number of users) for each of the time zones (the third evaluation item) computed for the specified area and the time zone in which the content is desired to be distributed (presented). The evaluation unit 12 stores information indicating a correspondence relationship between the evaluation rank and the population in the time zone illustrated in FIG. 5(a). The evaluation unit 12 determines the evaluation rank from the computed value of the population for each of the time zones in the area on the basis of the stored correspondence relationship.

The evaluation unit 12 refers to the value of the population ratio for each of the user attribute pieces computed for the specified area. The evaluation unit 12 computes a matching rate that is the value of the relevance between the user attribute and the content in the area (the fourth evaluation item) from the population ratio for each of the user attribute pieces and the target attribute of the content 100. For example, the evaluation unit 12 computes the matching rate by the following expression.

$$Matching Rate = Main Target ( a weight of 1 \text{.0} ) \times Population \text{} Ratio \text{} ( \% ) of \text{} Attribute \text{} of \text{} Main \text{} Target + Sub - Target ( a weight of 0.5 ) \times Popluation \text{} Ratio \text{} ( \% ) \text{} of \text{} Attribute of Sub - Target$$

The population ratio of each of the user attribute pieces for the specified area is assumed such that men in their teens are 40%, men in their 20s are 20%, and men in their 30s are 30%, and the target attribute of the content 100 is assumed such that main target is for men in their 30s, and the sub-target is for men in their 20s. In this case, the matching rate has the following value.

$$Matching Rate = Main Target ( a weight of 1. ) \times Population Ratio ( 40 \% ) of Attribute of Main Target + Sub - Target ( a weight of 0.5 ) \times Population Ratio ( 20 \% ) of Attribute of Sub - Target = 50 \%$$

The evaluation unit 12 stores information indicating a correspondence relationship between the evaluation rank illustrated and the matching rate in FIG. 5(b). The evaluation unit 12 determines the evaluation rank from the computed matching rate in the area on the basis of the stored correspondence relationship.

As illustrated in FIG. 3, the evaluation unit 12 stores a value Wi of a weight for each evaluation item i set in advance. The evaluation unit 12 computes a score Pi×Wi of each of the evaluation items i by multiplying an evaluation point Pi corresponding to the evaluation rank determined for each of the evaluation items i by the value Wi of the weight. The evaluation unit 12 computes a sum ΣPi×Wi of such values as the total evaluation value for the input of the information relating to the evaluation request.

The evaluation unit 12 stores in advance a correspondence relationship between the total evaluation value and a price per time (yen/hour), which is the value of the region, as a pricing table T2 according to the total evaluation value illustrated in FIG. 3. The evaluation unit 12 determines (evaluates) the price of the region in the AR space for the input of the information relating to the evaluation request on the basis of the stored pricing table T2 according to the total evaluation value.

The evaluation unit 12 outputs information indicating the determined price of the region. The evaluation unit 12, for example, transmits the information indicating the determined price of the region to the information processing device of the person who desires to present the content 100 in the AR space, which is an input source of the information relating to the evaluation request. The output of information indicating the evaluation result of the value of the region by the evaluation unit 12 may be performed in accordance with an output destination and a mode other than the above.

Note that, the evaluation by the evaluation unit 12 is performed in accordance with the input of the information relating to the evaluation request, but is not necessarily performed in accordance with the input. For example, the evaluation unit 12 may evaluate the value for all regions and all conditions (such as the time zone) set in advance.

In addition, the evaluation unit 12 just need to perform the aggregation based on the evaluation information including the position information indicating the position in the reality space of the information processing device 20 performing the AR display to evaluate the value of the region on the basis of the aggregation result, but it is not necessary to evaluate the region by using all the evaluation items described above, and the region may be evaluated by using any of the evaluation items described above. In addition, the evaluation unit 12 may evaluate the region by using other than the evaluation items described above. The above is the function of the region value evaluation system 10 according to this embodiment.

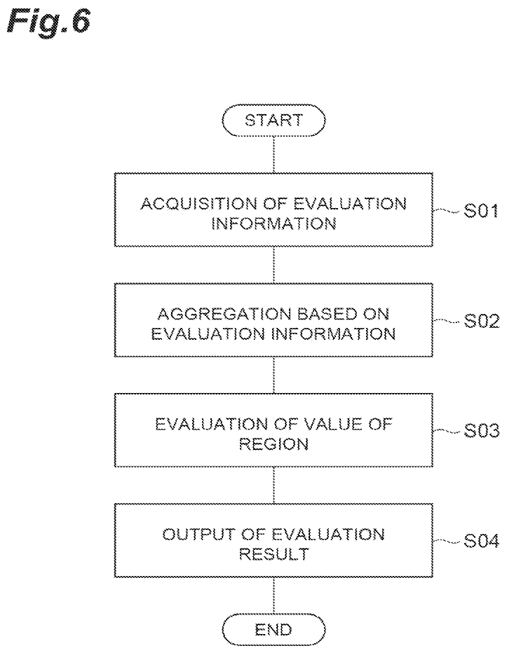

Subsequently, processing executed by the region value evaluation system 10 according to this embodiment (an operation method performed by the region value evaluation system 10) will be described by using a flowchart in FIG. 6. In this processing, first, the evaluation information acquisition unit 11 acquires the evaluation information used for the value evaluation of the region in the virtual space (S01). The evaluation information includes at least the position information indicating the position in the reality space of the information processing device 20 performing the display using the virtual space. Subsequently, the evaluation unit 12 performs the aggregation based on the evaluation information acquired by the evaluation information acquisition unit 11 (S02). Subsequently, the evaluation unit 12 evaluates the value of the region on the basis of the aggregation result (S03). Subsequently, the evaluation unit 12 outputs the information indicating the evaluation result of the value of the region (S04). The above is the processing executed by the region value evaluation system 10 according to this embodiment.

In this embodiment, the value of the region in the virtual space is evaluated by considering the position in the reality space of the information processing device 20 performing the display using the virtual space such as an AR display. Accordingly, for example, the value of the region to be evaluated can be in accordance with the advertisement effect of the region. Specifically, as described above, it is possible to evaluate the value of the region by considering the browsability of the content 100 of the user. Accordingly, according to this embodiment, it is possible to suitably evaluate the value of the region for presenting the content 100 such as an advertisement in the virtual space such as an AR space. In addition, as with this embodiment, by visualizing the value of the region in the AR space, it is possible to accelerate the sale of the region in the AR space.

In addition, as with the embodiment described above, the value of the region may be evaluated also in accordance with whether the region is included in the AR display in the information processing device 20. According to such a configuration, it is possible to more suitably evaluate the value of the region in accordance with the actual AR display in the information processing device 20. In addition, in this case, the value of the region may be evaluated also in accordance with the position of the region in the AR display. According to such a configuration, it is possible to even more suitably evaluate the value of the region in accordance with the position of the region in the AR display. Here, the above is not necessarily used for the evaluation of the value of the region.

In addition, as with the embodiment described above, the value of the region may be evaluated also in accordance with the length of the time for which the state set in advance is continued, in the time-series display using the AR space in the information processing device 20. According to such a configuration, it is possible to more suitably evaluate the value of the region in accordance with the status of the AR display in the information processing device 20. Here, the above is not necessarily used for the evaluation of the value of the region.

In addition, as with the embodiment described above, the position of the information processing device 20 may be estimated on the basis of the image of the reality space imaged by the imaging device provided in the information processing device 20 to acquire the position information. According to such a configuration, the position information can be acquired on the basis of the image of the reality space that is also used for the AR display. Accordingly, it is possible to easily and reliably evaluate the value of the region without requiring the positioning function of the information processing device 20 other than the above. Here, the position information of the information processing device 20 may be acquired by a method other than the above.

In addition, as with the embodiment described above, the value of the region may be evaluated also in accordance with whether the location corresponding to the region is included in the image of the reality space imaged by the imaging device provided in the information processing device 20. According to such a configuration, it is possible to more suitably evaluate the value of the region in accordance with the image of the reality space corresponding to the AR display in the information processing device 20. In addition, in this case, the value of the region may be evaluated also in accordance with the position of the location corresponding to the region in the image of the reality space. According to such a configuration, it is possible to even more suitably evaluate the value of the region in accordance with the position of the location corresponding to the region in the image of the reality space. Here, the above is not necessarily used for the evaluation of the value of the region.

In addition, as with the embodiment described above, the value of the region may be evaluated also in accordance with the length of the consecutive time for which the state set in advance is continued, in the image of the reality space imaged by the imaging device provided in the information processing device 20. According to such a configuration, it is possible to more suitably evaluate the value of the region in accordance with the status of the image of the reality space corresponding to the AR display in the information processing device 20. Here, the above is not necessarily used for the evaluation of the value of the region.

In addition, as with the embodiment described above, the evaluation information according to the time may be used for the evaluation of the value of the region. According to such a configuration, it is possible to more suitably evaluate the value of the region. In addition, the value of the region to be evaluated as described above may be in accordance with the time. According to such a configuration, it is possible to increase the convenience of the value of the region to be evaluated. For example, a region at a position corresponding to a station area is evaluated as having a high value in a time zone in which there are many people, such as a commuting time zone (8:00 to 9:00). Here, the time is not necessarily considered for the evaluation of the value of the region.

In addition, as with the embodiment described above, the attribute information indicating the attribute of the user of the information processing device 20 may be used for the evaluation of the value of the region. According to such a configuration, it is possible to more suitably evaluate the value of the region. In addition, as described above, the value of the region to be evaluated may be in accordance with the attribute of the user. According to such a configuration, it is possible to increase the convenience of the value of the region to be evaluated. For example, since a region at a position corresponding to an area in which young people gather, such as Shibuya, is regarded as having a high advertisement effect for the content 100 for young people, a value according to such regard is evaluated. Here, the attribute of the user is not necessarily considered for the evaluation of the value of the region.

Note that, some of the functions provided in the region value evaluation system 10 described above may be provided in another device such as the information processing device 20. In this case, a system including the other device may be the region value evaluation system.

Note that, a block diagram used for the description of the above embodiment illustrates the blocks of function units. Such function blocks (configuration units) are implemented by any combination of at least one of hardware and software. In addition, a method for implementing each of the function blocks is not particularly limited. That is, each of the function blocks may be implemented by using one physically or logically coupled device, or may be implemented by using a plurality of devices obtained by directly or indirectly (for example, in a wired or wireless manner) connecting two or more devices physically or logically separated from each other. The function block may be implemented by combining software with the one device or the plurality of devices.

The function includes determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but is not limited thereto. For example, the function block (the configuration unit) performing the transmitting is referred to as a transmitting unit or a transmitter. In either case, as described above, a method for implementing the function block is not particularly limited.

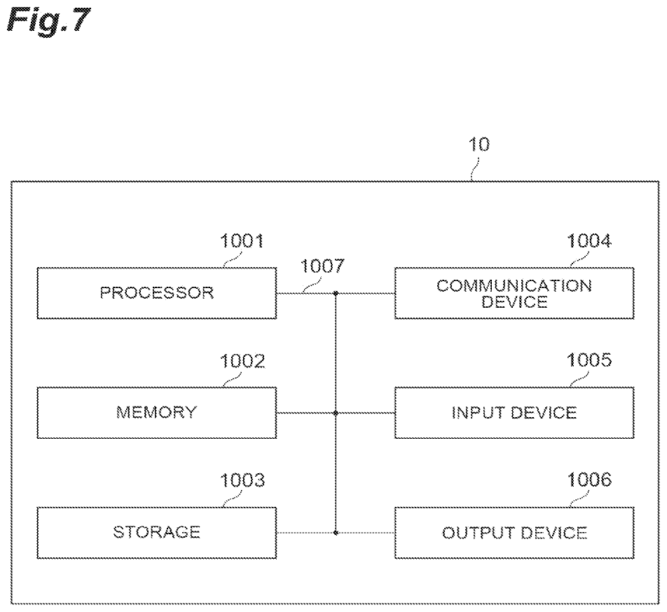

For example, the region value evaluation system 10 in one embodiment of the present disclosure may function as a computer performing information processing of the present disclosure. FIG. 7 is a diagram illustrating an example of a hardware configuration of the region value evaluation system 10 according to one embodiment of the present disclosure. The region value evaluation system 10 described above may be physically configured as a computer device including a processor 1001, a memory 1002, a storage 1003, a communication device 1004, an input device 1005, an output device 1006, a bus 1007, and the like. In addition, a hardware configuration of the information processing device 20 may also be the same as described herein.

Note that, in the following description, the word “device” can be replaced with a circuit, a unit, or the like. The hardware configuration of the region value evaluation system 10 may be configured to include one or a plurality of devices illustrated in the drawings, or configured to exclude some devices.

Each of the functions in the region value evaluation system 10 is implemented by reading predetermined software (program) on the hardware such as the processor 1001 and the memory 1002 such that the processor 1001 performs arithmetic, and controlling the communication of the communication device 1004 or controlling at least one of the reading and the writing of data in the memory 1002 and the storage 1003.

The processor 1001, for example, controls the entire computer by operating an operating system. The processor 1001 may be composed of a central processing unit (CPU) including an interface with a peripheral device, a control device, an arithmetic device, a register, and the like. For example, each of the functions in the region value evaluation system 10 described above may be implemented by the processor 1001.

In addition, the processor 1001 reads out a program (a program code), a software module, data, and the like from at least one of the storage 1003 and the communication device 1004 to the memory 1002, and executes various processing pieces in accordance with the program and the like. As the program, a program for allowing a computer to execute at least a part of the operation described in the above embodiment is used. For example, each of the functions in the region value evaluation system 10 may be implemented by a control program that is stored in the memory 1002 and operated in the processor 1001. It has been described that the various processing pieces described above are executed by one processor 1001, but the various processing pieces may be simultaneously or sequentially executed by two or more processors 1001. The processor 1001 may be implemented by one or more chips. Note that, the program may be transmitted from a network via an electric communication line.

The memory 1002 is a computer-readable recording medium, and for example, may be composed of at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), and the like. The memory 1002 may store a program (a program code), a software module, and the like that can be executed to carry out the information processing according to one embodiment of the present disclosure.

The storage 1003 is a computer-readable recording medium, and for example, may be composed of at least one of an optical disk such as a compact disc ROM (CD-ROM), a hard disk drive, a flexible disk, a magnetooptic disk (for example, a compact disk, a digital versatile disk, and a Blu-ray (Registered Trademark) disk), a smart card, a flash memory (for example, a card, a stick, and a key drive), a floppy (Registered Trademark) disk, a magnetic strip, and the like. The storage 1003 may be referred to as an auxiliary storage device. A storage medium provided in the region value evaluation system 10, for example, may be a database, a server, and other suitable media including at least one of the memory 1002 and the storage 1003.

The communication device 1004 is hardware (a transmitting and receiving device) for performing communication with respect to a computer via at least one of a wired network and a wireless network, and for example, is also referred to as a network device, a network controller, a network card, a communication module, and the like.

The input device 1005 is an input device (for example, a keyboard, a mouse, a microphone, a switch, a button, a sensor, and the like) receiving input from the outside. The output device 1006 is an output device (for example, a display, a speaker, an LED lamp, and the like) carrying out output to the outside. Note that, the input device 1005 and the output device 1006 may have an integrated configuration (for example, a touch panel).

In addition, each of the devices such as the processor 1001 and the memory 1002 is connected by the bus 1007 for performing the communication of the information. The bus 1007 may be configured by using a single bus, or may be configured by using different buses for each of the devices.

In addition, the region value evaluation system 10 may be configured by including hardware such as a microprocessor, a digital signal processor (DSP), an application specific integrated circuit (ASIC), a programmable logic device (PLD), and a field programmable gate array (FPGA), and a part or all of each of the function blocks may be implemented by the hardware. For example, the processor 1001 may be implemented by using at least one of the hardware.

The order of the processing procedure, the sequence, the flowchart, and the like of each of the aspects/embodiments described in the present disclosure may be changed unless there is contradiction. For example, in the method described in the present disclosure, the elements of various steps are presented by using an exemplary order, but the present disclosure is not limited to the presented specific order.

The input and output information or the like may be stored in a specific place (for example, a memory), or may be managed by using a management table. The input and output information or the like can be overwritten, updated, or edited. The output information or the like may be deleted. The input information or the like may be transmitted to other devices.

The judging may be performed by a value represented by 1 bit (0 or 1), may be performed by a truth value (Boolean: true or false), or may be performed by comparing numerical values (for example, comparing with a predetermined value).

Each of the aspects/embodiments described in the present disclosure may be used alone, may be used in combination, or may be used by being switched in accordance with the execution. In addition, the notifying of predetermined information (for example, the notifying of “X”) is not limited to being performed explicitly, but may be performed implicitly (for example, by not performing the notifying of the predetermined information).

The present disclosure has been described in detail, but it is obvious to a person skilled in the art that the present disclosure is not limited to the embodiment described in the present disclosure. The present disclosure can be carried out as modifications and variations without departing from the spirit and the scope of the present disclosure defined by the claims. Therefore, the description of the present disclosure is for illustrative purpose and is not intended to have any restrictive meaning on the present disclosure.

The software should be broadly construed to indicate an instruction, an instruction set, a code, a code segment, a program code, a program, a sub-program, a software module, an application, a software application, a software package, a routine, a sub-routine, an object, an executable file, an execution thread, a procedure, a function, and the like, regardless of being referred to as software, firmware, middleware, a microcode, and a hardware description language, or referred to as other names.

In addition, the software, the instruction, the information, and the like may be transmitted and received via a transmission medium. For example, in a case where the software is transmitted from a website, a server, or other remote sources by using at least one of a wired technology (a coaxial cable, an optical fiber cable, a twisted pair, a digital subscriber line (DSL), and the like) and a wireless technology (an infrared ray, a microwave, and the like), at least one of the wired technology and the wireless technology is included in the definition of the transmission medium.

The terms “system” and “network” used in the present disclosure are used interchangeably.

In addition, the information, the parameter, and the like described in the present disclosure may be represented by using an absolute value, may be represented by using a relative value from a predetermined value, or may be represented by using another corresponding information.

The term “determining” used in the present disclosure may include various operations. “Determining”, for example, may include considering judging, calculating, computing, processing, deriving, investigating, search (looking up or inquiry) (for example, search in a table, a database, or another data structure), and ascertaining as “determining”. In addition, “determining” may include considering receiving (for example, receiving information), transmitting (for example, transmitting information), input, output, and accessing (for example, accessing data in a memory) as “determining”. In addition, “determining” may include considering resolving, selecting, choosing, establishing, comparing, and the like as “determining”. That is, “determining” may include “determining” any operation. In addition, “determining” may be replaced with “assuming”, “expecting”, “considering”, and the like.

The terms “connected” and “coupled”, or any variations thereof indicate any direct or indirect connection or coupling between two or more elements, and may include one or more intermediate elements between two elements “connected” or “coupled” to each other. The elements may be coupled or connected to each other physically, logically, or in combination thereof. For example, “connecting” may be replaced with “accessing”. In a case where the terms are used in the present disclosure, it can be considered that two elements are “connected” or “coupled” to each other by using at least one of one or more electric wires, cables, and printed electric connections, and as several non-determinative and non-inclusive examples, by using electromagnetic energy or the like having a wavelength in a wireless frequency region, a microwave region, and a light (both of visible and non-visible) region.

The expression “on the basis of” used in the present disclosure does not indicate “only on the basis of” unless explicitly stated otherwise. In other words, the expression “on the basis of” indicates both of “only on the basis of” and “at least on the basis of”.

Any reference to the elements using the addresses “first”, “second”, and the like used in the present disclosure does not generally limit the amount or the order of the elements. Such addresses can be used in the present disclosure as a convenient method for distinguishing two or more elements. Therefore, the reference to the first and second elements does not indicate that only two elements can be adopted or the first element necessarily precedes the second element in any way.

In the present disclosure, in a case where “include”, “including”, and variations thereof are used, such terms are intended to be inclusive as with the term “comprising”. Further, the term “or” used in the present disclosure is intended not to be exclusive OR.

In the present disclosure, for example, in a case where articles are added by translation, such as a, an, and the in English, the present disclosure may include that the nouns following such articles are in a plural form.

In the present disclosure, the term “A and B are different” may indicate that “A and B are different from each other”. Note that, the term may indicate that “each of A and B is different from C”. The terms “separated”, “coupled”, and the like may be construed as with “different”.

### REFERENCE SIGNS LIST

10: region value evaluation system, 11: evaluation information acquisition unit, 12: evaluation unit, 20: information processing device, 1001: processor, 1002: memory, 1003: storage, 1004: communication device, 1005: input device, 1006: output device, 1007: bus.

1. A region value evaluation system evaluating a value of a region to which display information to be displayed is allocated, in a virtual space that is used for a display in an information processing device and corresponds to a reality space in a position, the system comprising circuitry configured to:
acquire evaluation information including position information indicating a position in the reality space of the information processing device performing a display using the virtual space; and
perform aggregation based on the acquired evaluation information to evaluate the value of the region on the basis of an aggregation result.

2. The region value evaluation system according to claim 1,
wherein the circuitry acquires the evaluation information including display status information indicating a display status using the virtual space in the information processing device, and
evaluates the value of the region also in accordance with whether the region is included in the display using the virtual space in the information processing device, which is indicated by the acquired display status information.

3. The region value evaluation system according to claim 2,
wherein the circuitry evaluates the value of the region also in accordance with a position of the region in the display using the virtual space in the information processing device.

4. The region value evaluation system according to claim 1,
wherein the circuitry acquires the evaluation information including display status information indicating a time-series display status using the virtual space in the information processing device, and
evaluates the value of the region also in accordance with a length of a time for which a state set in advance is continued, in a time-series display using the virtual space in the information processing device, which is indicated by the acquired display status information.

5. The region value evaluation system according to claim 1,
wherein the circuitry acquires an image of the reality space imaged by an imaging device provided in the information processing device, estimates the position of the information processing device on the basis of the acquired image of the reality space, and acquires the position information.

6. The region value evaluation system according to claim 1,
wherein the circuitry acquires the evaluation information including an image of the reality space imaged by an imaging device provided in the information processing device, and
evaluates the value of the region also in accordance with whether a location corresponding to the region is included in the acquired image of the reality space.

7. The region value evaluation system according to claim 6,
wherein the circuitry evaluates the value of the region also in accordance with a position of the location corresponding to the region in the image of the reality space.

8. The region value evaluation system according to claim 1,
wherein the circuitry acquires the evaluation information including time-series images of the reality space imaged by an imaging device provided in the information processing device, and
evaluates the value of the region also in accordance with a length of a consecutive time for which a state set in advance is continued, in the acquired time-series images of the reality space.

9. The region value evaluation system according to claim 1,
wherein the circuitry acquires the evaluation information according to time.

10. The region value evaluation system according to claim 1,
wherein the circuitry acquires the evaluation information including attribute information indicating attribute of a user of the information processing device.

11. The region value evaluation system according to claim 2,
wherein the circuitry acquires the evaluation information including display status information indicating a time-series display status using the virtual space in the information processing device, and
evaluates the value of the region also in accordance with a length of a time for which a state set in advance is continued, in a time-series display using the virtual space in the information processing device, which is indicated by the acquired display status information.

12. The region value evaluation system according to claim 3,
wherein the circuitry acquires the evaluation information including display status information indicating a time-series display status using the virtual space in the information processing device, and
evaluates the value of the region also in accordance with a length of a time for which a state set in advance is continued, in a time-series display using the virtual space in the information processing device, which is indicated by the acquired display status information.
